(19) United States
(12) Patent Application Publication
(10) Pub. No.: US 2004/0246095 A1
(43) Pub. Date: Dec. 9, 2004

(54) Security device

(76) Inventors: Thomas Berger, Hahnbach (DE); Robert Gassner, Amberg (DE); Andre Kling, Erlangen (DE); Hartmut Schumacher, Ebermannsdorf (DE)

Correspondence Address: HARNESS, DICKEY & PIERCE, P.L.C., P.O.BOX 8910, RESTON, VA, 20195, US

(21) Appl. No.: 10/493,606

(22) PCT Filed: Oct. 17, 2002
(86) PCT No.: PCT/DE02/03931

(30) Foreign Application Priority Data
Oct. 24, 2001 (DE) 10152349.1

(51) Int. Cl. H04Q 1/00; G05B 19/00

(52) U.S. Cl. 340/5.22; 340/5.7

(57) ABSTRACT

A security device (1) is disclosed, which permits the controlled access of authorised personnel to vulnerable security regions. According to the invention, the security device (1) is provided with a bus system (3), connecting a central control device to several actuators (4), each of which is allocated to one of the security regions (2). Access authorisation is monitored and controlled by means of a personal identification device (6).

This application is the national phase under 35 U.S.C. § 371 of PCT International Application No. PCT/DE02/03931 which has an International filing date of Oct. 17, 2002, which designated the United States of America and which claims priority on German Patent Application number DE 101 52 349.1 filed Oct. 24, 2001, the entire contents of which is hereby incorporated herein by reference.

### FIELD OF THE INVENTION

The invention generally relates to a security device. Preferably, it relates to one for controlled access to various security areas, in which installations or installation components, for example machines or production equipment, are located.

### BACKGROUND OF THE INVENTION

Security devices for use in automobiles are known for example from EP 0 924 123 A2.

In the industrial sector, many devices, machines, automatic units, complete installations and associated control systems are operated and are usually switched on and off, operator-controlled, set up, programmed or maintained manually. Used here as the interface between man and machine are command and signaling devices, for example pushbuttons, illuminated indicators, key-operated control switches, etc. and also membrane keyboards, touch screens and corresponding devices.

Apart from the risks caused by the way in which the machine operates, these activities also entail many further hazards and risks for the people who have to act as operators for them. To prevent such hazards, corresponding protective systems are prescribed in the accident prevention regulations.

These protective systems cordon off dangerous areas for example, provide warnings when inadmissible operating conditions occur, allow intervention or access only by special authorized persons or only permit specially trained persons to act as operators. For all these protective measures, special, suitable and reliable safeguards are required, ensuring that only authorized persons have the respective access. It is problematical that these protective systems are expensive, elaborate and inflexible, and that they are increasingly failing to meet the ever more demanding safety regulations.

Previously, dangerous areas of the machine were closed off by protective doors, protective grilles or the like. On the other hand, access authorization is controlled by way of locks and complete locking systems. They serve for the authorized switching on and off of a cell of the machine, of the entire machine or of a complete installation for the setting-up operation, operation with/without a contactor, operation online/offline, manual intervention, automatic/manual mode, starting up/running up or running down dangerous processes or the like or switching over the production processes for the production of a different variant on one machine, etc.

The locks are formed in this example as key-operated switches with electrical contacts. However, combination locks, magnetic cards or corresponding devices may also be used. The machines are provided with suitable locks or locking systems, which actuate electrical contacts or generate other secure electrical signals, which in turn act in the way prescribed on the control of the installation. The respectively authorized persons receive the associated key or keys, magnetic cards or codes.

### SUMMARY OF THE INVENTION

An embodiment of the invention includes an object of providing a security device which permits controlled access to security areas where risks or hazards exist only to authorized persons in a simple and convenient way and is nevertheless very flexible and secure.

The security device of one embodiment includes:

a) a bus system, which connects a central control device to a number of actuators, which are respectively assigned to at least one of the security areas and permit access to the latter, for example for operator control of machines or machine components located therein,

b) the control device has at least one first personal identification device, a programming unit, a memory and an electronic module,

c) the first personal identification device serves for registering personal identification features,

d) the memory serves for storing personal identification features of different persons who are to be given access authorization, at least to one of the security areas,

e) the programming unit serves for programming the access authorization to various security areas, person-dependently by assignment of personal identification features,

f) after identification of a person with access authorization on the basis of a comparison of registered personal identification features with personal identification features stored in the memory and after inquiry of the programmed access authorization, the electronic module generates a message dependent on said access authorization for transmission via the bus system, by which one or more of the actuators release access to the assigned security areas in a way corresponding to the access authorization determined.

Special advantages are obtained if the authorization for the machine to be operated or controlled by an operator is applied by use of a suitable personalized identification methodology which cannot be falsified and cannot be forgotten or lost.

### BRIEF DESCRIPTION OF THE DRAWINGS

Further advantages, features and details of the invention will become evident from the description of illustrated exemplary embodiments given hereinbelow and the accompanying drawings, which are given by way of illustration only and thus are not limitative of the present invention, wherein:

FIG. 1 shows a security device according to an embodiment of the invention

FIG. 2 shows an operating flow diagram for a secure machine area and

FIG. 3 shows a flow diagram for master operation.

### DETAILED DESCRIPTION OF THE PREFERRED EMBODIMENTS

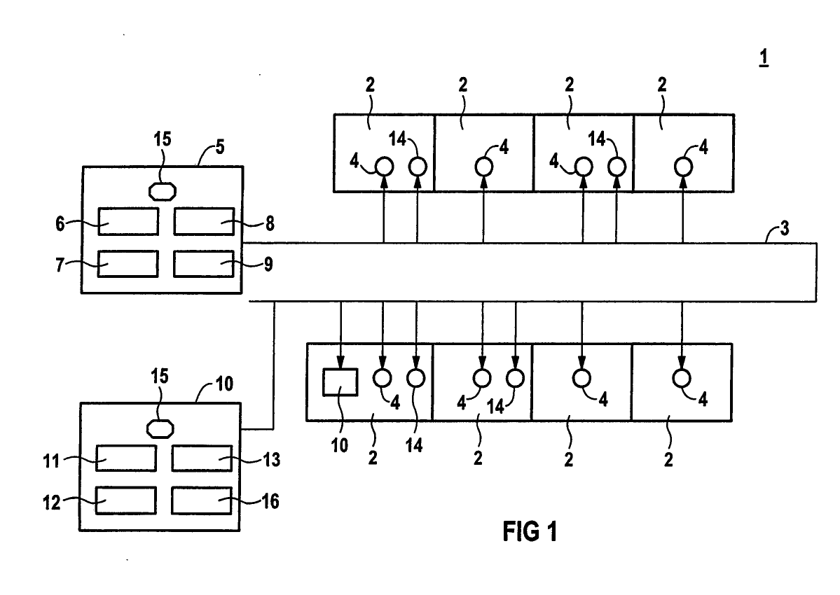

Represented in FIG. 1 is a security device 1 for controlled access to various security areas 2, in which installations or installation components, for example machines or production equipment, are located. The security device 1 includes a bus system 3, which connects a central control device 5 to a number of actuators 4, which are respectively assigned to at least one of the security areas 2, and permit access to the latter, for example for operator control of machines or machine components located therein.

The control device 5 has at least one first personal identification device 6, a programming unit 7, a memory 8 and an electronic module 9. The first personal identification device 6 serves for registering personal identification features. The memory 8 is provided for storing personal identification features of different persons who are to be given access authorization, at least to one of the security areas 2.

Furthermore, if need be, the respective access rights and the desired security logs are stored there. The programming unit 7 can be used for programming the access authorization to various security areas 2, person-dependently by assignment of personal identification features.

After identification of a person with access authorization on the basis of a comparison of registered personal identification features with personal identification features stored in the memory 8 and after inquiry of the programmed access authorization, the electronic module 9 generates a message dependent on the access authorization for transmission via the bus system 3. By this, one or more of the actuators 4 release access to the assigned security areas 2 in a way corresponding to the access authorization determined.

Optionally, at least one decentralized access-control command device 10, which has at least one second personal identification device 11 for registering personal identification features and a memory 12 for storing personal identification features of different persons who are to be given access authorization, at least to one of or a group of the security areas, may be additionally connected to the bus system 3. The access-control command device 10 comprises an electronic module 13, which, after identification of a person with access authorization on the basis of a comparison of registered personal identification features with personal identification features stored in the memory 12 and after inquiry of the programmed access authorization, generates a message dependent on the access authorization for transmission via the bus system 3. By this, one or more of the actuators 4 release access to the one or group of assigned security areas 2.

Furthermore, further actuators 14, which serve for controlling installations or installation components located in the security areas 2 and the activation of which can be triggered by way of at least one command device 15 in the central control device 5 or in the decentralized access-control command device or devices 10 or directly at the security area 2, may be connected to the bus system 3.

The programming unit 7 contains a running program, which authorizes a master person, who is identifiable by their personal identification features, to grant for the first time and to change access authorizations and also to issue logs and/or evaluations.

The personal identification advantageously takes place by the registration and evaluation of suitable biometric data. Used for this purpose for example are the features of a fingerprint or hand print, but use of the human voice (voice control) or image acquisition, for example of facial features suitable for identification, is also possible.

According to an embodiment of the invention, a complete locking system for a security device is replaced by personal identification devices, for example a few fingerprints, preferably just a single fingerprint, per security device. The identification of all persons who have to do with this security device and the granting of the correct access authorization for the respective person only take place from this one location, or where the control device 5 or the access-control command device 10 to be used for this is accommodated. If there is a positive identification, the electronic module 9 or 13 clears access to the security area 2 correspondingly assigned to the person. A bus system 3 is preferably used for this purpose.

The extent of the authorization is stored in the software, i.e. the programming unit 7 and the memory 8, so that locking systems, such as for example general keys, main keys and individual keys, are no longer required. The structure may be constructed in the to some extent tried-and-tested and known hierarchical levels.

However, according to an embodiment of the invention, it can also be interlinked in any way desired and be configured freely and individually according to personal requirements. For example, the master can switch all the machines of his area of responsibility on and off, the operator personnel can only switch the respectively assigned machine on and off and the service specialist for the laser stations can switch all the stations throughout the works on and off. Each receives his individual tailor-made authorization.

Responsible for granting authorization is a master person, who is likewise authorized to do this by means of the same system. A combination of personal identification with a further identification, for example a code, is possible and appropriate for special security standards. The master person can read in the identification features and grant the associated access authorization with the aid of suitable software.

By contrast with the locking system, this can be accomplished very quickly, at low cost and flexibly. This is of greater importance at the present time of frequent personnel changes. Similarly, authorization can be granted quickly, inexpensively and individually according to training, level of familiarization or an emergency situation. The same of course also applies correspondingly in the converse sense. Nevertheless, full protection and a very high level of security against falsification remain at all times.

According to an embodiment of the invention, the complete system can be integrated into the existing customary data-processing environments for machine control, provided that they conform to the required security requirements.

The granting of authorization is stored by software in the security area and cannot be changed retrospectively, even by the main person responsible, i.e. the master person. Consequently, if need be, the authorization rights applicable at any point in time can also be established later.

Entering of the authorization can preferably take place at an input device at a central location, for example a central control device 5. With the aid of the secure bus system 3, checking can be performed on the spot. To relieve the bus system 3, however, the storage of the data required for the respective security area 2 and the evaluation may also take place decentrally on the spot with the aid of the access-control command device 10.

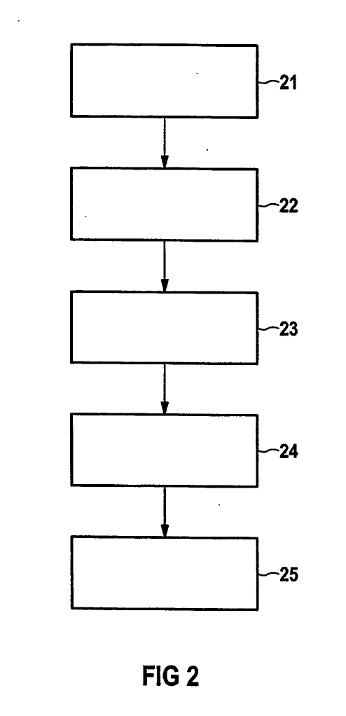

The operating sequences in the secure machine area are represented in a flow diagram according to FIG. 2. In this diagram, the blocks 21, 22, 23, 24, 25 show the individual method steps.

In the first step according to block 21, the personal identification features are recorded, for example at the central control device 5 of a machine line by means of a fingerprint.

In the second step according to block 22, the identification of the personal identification features and the establishment of the access authorizations assigned to the identified person for the respective security area 2 take place. This may take place centrally in the control device 5 or else decentrally in the access-control command device 10.

In the third step according to block 23, the activity request is entered by way of the command device 15 to be used for this.

In the fourth step according to block 24, the function for the activity is activated or released in a way corresponding to the access authorization. Thus, the control device 5 receives the order to bring the machine or a cell of the same into the desired state, in order that the activities can be performed.

In step five according to block 25, the activity request is deactivated, i.e. the command device 15 is possibly reset.

A further favorable refinement is obtained if the master person performs the programming by way of a hand-held device, which is connected on the spot directly to the machine at a programming socket.

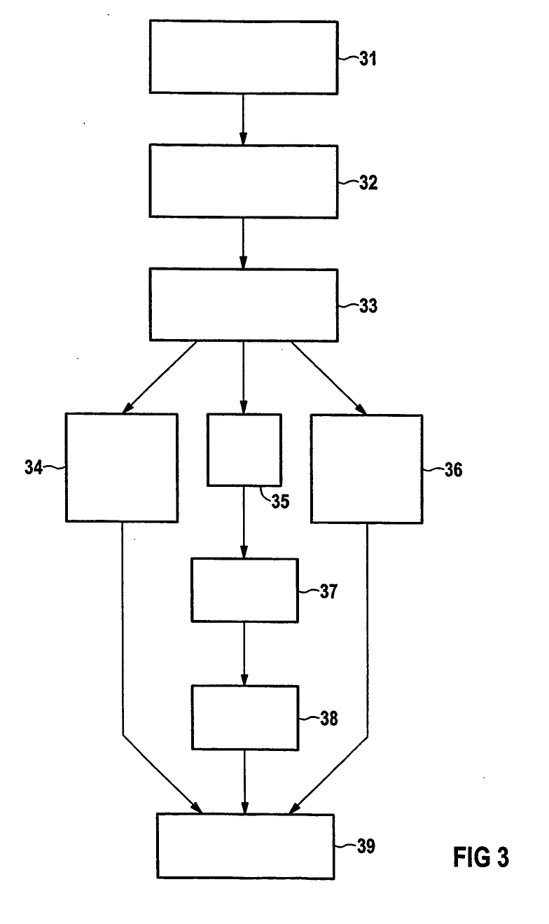

An example of master operation is illustrated by the flow diagram according to FIG. 3. Here, in a first step according to block 31, the programming status is activated, for example by connecting a programming device. In the second step according to block 32, the master person is identified, for example by means of a fingerprint and, if need be, with an additional code. In the third step according to block 33, the master person establishes the desired activity by way of the programming device, if a number of functions are available. This may be, for example, changing the access authorization of persons according to block 34, including a new person according to block 35 or requesting a log or evaluations according to block 36. Following on from block 35, the identification of the new person takes place according to block 37 and the subsequent establishment of their rights takes place according to block 38. The three activities mentioned above are completed with the step of ending the programming status according to block 39.

The right of access of the master person may be combined with a further method of identification. Authorization rights cannot be changed retrospectively. The authorization rights applicable at any point in time can also be established later.

The electronic module 9 is formed in such a way that even security areas 2 where two or more persons have to be present at the same time for safety or security reasons, this is made possible by way of a registration device, which has to be operated by the required persons within a predetermined time window. For this purpose, the electronic module 9 is provided with a timing circuit for generating a time window, in which the personal identification device 6 registers personal identification features of a number of persons. All the relevant procedures can be stored and logged, and if need be visually displayed and evaluated.

One appropriate version is that of a setup with two fingerprints, where for safety reasons the person acting as the operator must have both hands in a safe place when an action is initiated, for example in order to initiate a punching operation.

Furthermore, there are areas where, for safety or security reasons, for example two or more persons must be present at the same time. This is solved by the relevant fingerprint having to be provided within a predetermined time window by the required persons to effect release. Here, too, the advantage is that this high security requirement cannot be overcome by deception. All persons have to be actually present for access to be authorized; borrowed or stolen keys are a thing of the past.

A further appropriate version of an embodiment of the invention is the possibility of storing, logging, visually displaying and evaluating all instances of access. This makes it possible for example to detect how often a machine had to be repaired, how often a cell had a problem, when and by whom inadmissible intervention took place, whether customer service had already been there, when it was there the last time, how long the operating times were, etc.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A security device for a machine to be at least one of operated and controlled by an operator, and for controlled access to various security areas in which at least one of installations and installation components, are located, comprising:
a central control device including,
at least one first personal identification device,
a programming unit,
a memory, and
an electronic module, wherein the
first personal identification device is for registering personal identification features,
the memory is for storing personal identification features of different persons to be given access authorization to at least one of the security areas,
the programming unit is for programming the access authorization to various security areas, person-dependently by assignment of personal identification features; and
a bus system connecting the central control device to a plurality of actuators respectively assigned to at least one of the security areas and adapted to permit access to the at least one of the security areas, for at least one of the operation and operator control of at least one of machines and machine components located therein, wherein
after identification of a person with access authorization on the basis of a comparison of registered personal identification features with personal identification features stored in the memory and after inquiry of the programmed access authorization, the electronic module of the central control device is adapted to generate a message dependent on the access authorization for transmission via the bus system, by which at least one of the actuators release access to the assigned security areas in a way corresponding to the access authorization determined.

2. The security device as claimed in claim 1, wherein at least one access-control command device includes,
at least one second personal identification device for registering personal identification features,
a memory for storing personal identification features of different persons who are to be given access authorization, at least to one of or a group of the security areas being connected to the bus system, and
an electronic module, which, after identification of a person with access authorization on the basis of a comparison of registered personal identification features with personal identification features stored in the memory and after inquiry of the programmed access authorization, generates a message dependent on said access authorization for transmission via the bus system, by which at least one of the actuators release access to the one or group of assigned security areas.

3. The security device as claimed in claim 1, including further actuators, which are for controlling at least one of installations and installation components located in the security areas and the activation of which are triggerable by at least one command device in at least one of the control device, the access-control command device and access-control command devices, the further actuators being connected to the bus system.

4. The security device as claimed in claim 1, wherein the programming unit contains a running program, which authorizes a master person, identifiable by their personal identification features, to grant for the first time and to change access authorizations and also to issue at least one of logs and evaluations.

5. The security device as claimed in claim 1, wherein the memory is for storing the respective access rights of the persons.

6. The security device as claimed in claim 1, wherein security logs are stored in the memory.

7. The security device as claimed in claim 1, wherein the personal identification features are biometric.

8. The security device as claimed in claim 2, including further actuators, which are for controlling at least one of installations and installation components located in the security areas and the activation of which are triggerable by at least one command device in at least one of the control device, the access-control command device and access-control command devices, the further actuators being connected to the bus system.

9. The security device as claimed in claim 2, wherein the programming unit contains a running program, which authorizes a master person, identifiable by their personal identification features, to grant for the first time and to change access authorizations and also to issue at least one of logs and evaluations.

10. The security device as claimed in claim 3, wherein the programming unit contains a running program, which authorizes a master person, identifiable by their personal identification features, to grant for the first time and to change access authorizations and also to issue at least one of logs and evaluations.

11. The security device as claimed in claim 2, wherein the memory is for storing the respective access rights of the persons.

12. The security device as claimed in claim 2, wherein security logs are stored in the memory.

13. The security device as claimed in claim 2, wherein the personal identification features are biometric.

14. A security device, comprising:
a central control device including,
at least one device, adapted to obtain personal identification features,
a unit, adapted to program access authorization to a plurality of security areas, and
a memory, adapted to store personal identification features for at least one person to be given access authorization to at least one of the plurality of security areas; and
a bus system, connecting the central control device to a plurality of actuators respectively assigned to at least one of the security areas and adapted to permit access to a security area, wherein upon obtained personal identification features corresponding to personal identification features stored in the memory, a message is sent via the bus system, in response to which at least one of the actuators is adapted to release access to an assigned security area based upon access authorization determined.

15. The security device as claimed in claim 14, wherein the memory is adapted to store respective access rights of the persons.

16. The security device as claimed in claim 14, wherein security logs are stored in the memory.

17. The security device as claimed in claim 14, wherein the personal identification features are biometric.

18. The security device as claimed in claim 14, including further actuators, which are for controlling at least one of installations and installation components located in the security areas and the activation of which are triggerable by at least one command device in at least one of the control device, the access-control command device and access-control command devices, the further actuators being connected to the bus system.
